(19) United States
(12) Patent Application Publication
(10) Pub. No.: US 2018/0206259 A1
(43) Pub. Date: Jul. 19, 2018

(54) Method and Apparatus for Detecting and Processing Resource Overlapping and System

(71) Applicant: FUJITSU LIMITED, Kawasaki-shi (JP)

(72) Inventors: Weiwei WANG, Beijing (CN); XIN WANG, Beijing (CN); Lei SONG, Beijing (CN)

(73) Assignee: FUJITSU LIMITED, Kawasaki-shi (JP)

(21) Appl. No.: 15/922,331

(22) Filed: Mar. 15, 2018

Related U.S. Application Data
(63) Continuation of application No. PCT/CN2015/091185, filed on Sep. 30, 2015.

(51) Int. Cl. H04W 72/12; H04W 56/00; H04W 28/16; H04W 72/04

(52) U.S. Cl. CPC H04W 72/1257; H04W 72/1284; H04W 72/042; H04W 56/0055; H04W 28/16; H04W 56/001

(57) ABSTRACT

Embodiments of this disclosure provide methods and apparatuses for detecting and processing resource overlapping and a system. The method for detecting resource overlapping applicable to a terminal (UE) includes: transmitting timing reference information to a transmission point serving for the terminal, so that the transmission point detects whether resources allocated by it for the terminal are overlapped with resources allocated by other transmission points for the terminal according to the timing reference information. When a terminal is served by multiple transmission points, with the embodiments of this disclosure, resource overlapping may be avoided, and degradation of terminal performance resulted from asynchronism of the timing of the multiple transmission points may be overcome.

### CROSS REFERENCE TO RELATED APPLICATIONS

This application is a continuation application of International Application PCT/CN2015/091185 filed on Sep. 30, 2015, the entire contents of which are incorporated herein by reference.

### FIELD

This disclosure relates to the field of communications technologies, and in particular to a method and an apparatus for detecting and processing resource overlapping and a system.

### BACKGROUND

In a 5G network, in order to improve a system capacity, a terminal (user equipment, UE) may be served by multiple transmission points (TPs). However, as distances between the TPs and a user are different and timing for transmitting data is different, it will result in asynchronism of timing of the TPs in communications with the user. Thus, it is possible that when the terminal is receiving/transmitting data from/to a TP, another TP starts to transmit data to the terminal or receive data from the terminal. In this case, the user may loss the data, and then the terminal performance is degraded.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In an existing mechanism, when the terminal is in communications with multiple TPs, differences between the asynchronism of the timing of the TPs is relatively small, and will not result in loss of the terminal performance. However, in a future 5G network, big and small base stations are networked in a hybrid manner, differences between coverage scopes of the base stations are relatively large, and loss of terminal performance will occur resulted from the above asynchronism.

In order to solve the above problem, embodiments of this disclosure provide a method and an apparatus for detecting and processing resource overlapping and a system.

According to a first aspect of the embodiments of this disclosure, there is provided an apparatus for detecting resource overlapping, applicable to a terminal (UE), the apparatus including:

a transmitting unit configured to transmit timing reference information to transmission points serving for the terminal, so that the transmission points detect whether resources allocated by them for the terminal are overlapped with resources allocated by other transmission points for the terminal according to the timing reference information.

According to a second aspect of the embodiments of this disclosure, there is provided an apparatus for detecting resource overlapping, applicable to a transmission point, the apparatus including:

a detecting unit configured to detect whether resources allocated by the transmission point for a terminal are overlapped with resources allocated by other transmission points for the terminal according to timing reference information.

According to a third aspect of the embodiments of this disclosure, there is provided an apparatus for processing resource overlapping, applicable to a transmission point, the apparatus including:

a transmitting unit configured to transmit indication information to other transmission points or a terminal, the indication information being used to indicate that resources allocated by the transmission point for the terminal are overlapped with resources allocated by the other transmission points for the terminal, and/or a scheduling scheme of overlapped resources;

wherein, the transmission point and the other transmission points jointly serve for the terminal.

According to a fourth aspect of the embodiments of this disclosure, there is provided an apparatus for processing resource overlapping, applicable to a terminal, the apparatus including:

a receiving unit configured to receive indication information transmitted by a transmission point, the indication information being used to indicate that resources allocated by the transmission point for the terminal are overlapped with resources allocated by other transmission points for the terminal, and/or a scheduling scheme of the overlapped resources;

wherein, the transmission point and the other transmission points jointly serve for the terminal.

According to a fifth aspect of the embodiments of this disclosure, there is provided a method for detecting resource overlapping, applicable to a terminal (UE), the method including:

transmitting timing reference information by the terminal to transmission points serving for the terminal, so that the transmission points detect whether resources allocated by them for the terminal are overlapped with resources allocated by other transmission points for the terminal according to the timing reference information.

According to a sixth aspect of the embodiments of this disclosure, there is provided a method for detecting resource overlapping, applicable to a transmission point, the method including:

detecting by the transmission point whether resources allocated by the transmission point for a terminal are overlapped with resources allocated by other transmission points for the terminal according to timing reference information.

According to a seventh aspect of the embodiments of this disclosure, there is provided a method for processing resource overlapping, applicable to a transmission point, the method including:

transmitting indication information by the transmission point to other transmission points or a terminal, the indication information being used to indicate that resources allocated by the transmission point for the terminal are overlapped with resources allocated by the other transmission points for the terminal, and/or a scheduling scheme of overlapped resources;

wherein, the transmission point and the other transmission points jointly serve for the terminal.

According to an eighth aspect of the embodiments of this disclosure, there is provided a method for processing resource overlapping, applicable to a terminal, the method including:

receiving by the terminal indication information transmitted by a transmission point, the indication information being used to indicate that resources allocated by the transmission point for the terminal are overlapped with resources allocated by other transmission points for the terminal, and/or a scheduling scheme of the overlapped resources;

wherein, the transmission point and the other transmission points jointly serve for the terminal.

According to a ninth aspect of the embodiments of this disclosure, there is provided UE, including the apparatus as described in the first or the fourth aspect.

According to a tenth aspect of the embodiments of this disclosure, there is provided a transmission point device, including the apparatus as described in the second or the third aspect.

According to an eleventh aspect of the embodiments of this disclosure, there is provided a communications system, including the UE as described in the ninth aspect and the transmission point device as described in the tenth aspect.

An advantage of the embodiments of this disclosure exists in that when a terminal is served by multiple transmission points, with the embodiments of this disclosure, resource overlapping may be avoided, and degradation of terminal performance resulted from asynchronism of the timing of the multiple transmission points may be overcome.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a timing reference point of a transmission point;

FIG. 2 is a schematic diagram of time advance of uplink transmission;

FIG. 3 is a schematic diagram of a scenario of resource overlapping;

FIG. 4 is a schematic diagram of another scenario of resource overlapping;

FIG. 5 is a schematic diagram of a further scenario of resource overlapping;

FIG. 6 is a schematic diagram of still another scenario of the resource overlapping;

FIG. 7 is a schematic diagram of a structure of one implementation of an apparatus for detecting resource overlapping of an embodiment;

FIG. 8 is a schematic diagram of a structure of another implementation of the apparatus for detecting resource overlapping of the embodiment;

FIG. 9 is a schematic diagram of a structure of one implementation of an apparatus for processing resource overlapping of an embodiment;

FIG. 10 is a schematic diagram of a structure of another implementation of the apparatus for processing resource overlapping of the embodiment;

FIG. 11 is a schematic diagram of a structure of a further implementation of the apparatus for processing resource overlapping of the embodiment;

FIG. 12 is a flowchart of one implementation of a method for detecting resource overlapping of an embodiment;

FIG. 13 is a flowchart of another implementation of the method for detecting resource overlapping of the embodiment;

FIG. 14 is a flowchart of one implementation of a method for processing resource overlapping of an embodiment;

FIG. 15 is a flowchart of another implementation of the method for processing resource overlapping of the embodiment;

FIG. 16 is a flowchart of a further implementation of the method for processing resource overlapping of the embodiment;

FIG. 17 is a schematic diagram of a hardware structure of one implementation of a transmission point device of an embodiment;

FIG. 18 is a schematic diagram of a hardware structure of one implementation of UE of an embodiment; and

FIG. 19 is a topology of a communications system of an embodiment.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of this disclosure shall be described below with reference to the accompanying drawings. However, these embodiments are illustrative only, and are not intended to limit this disclosure.

In the embodiments of this disclosure, for the sake of description, taking that a terminal is served by two transmission points as an example, each of the transmission points may possibly be a stand-alone base station, or may be a transmission node connected to the same virtual base station pool. The two transmission points may cover different cells with different cell IDs, and may cover different cells with identical cell IDs.

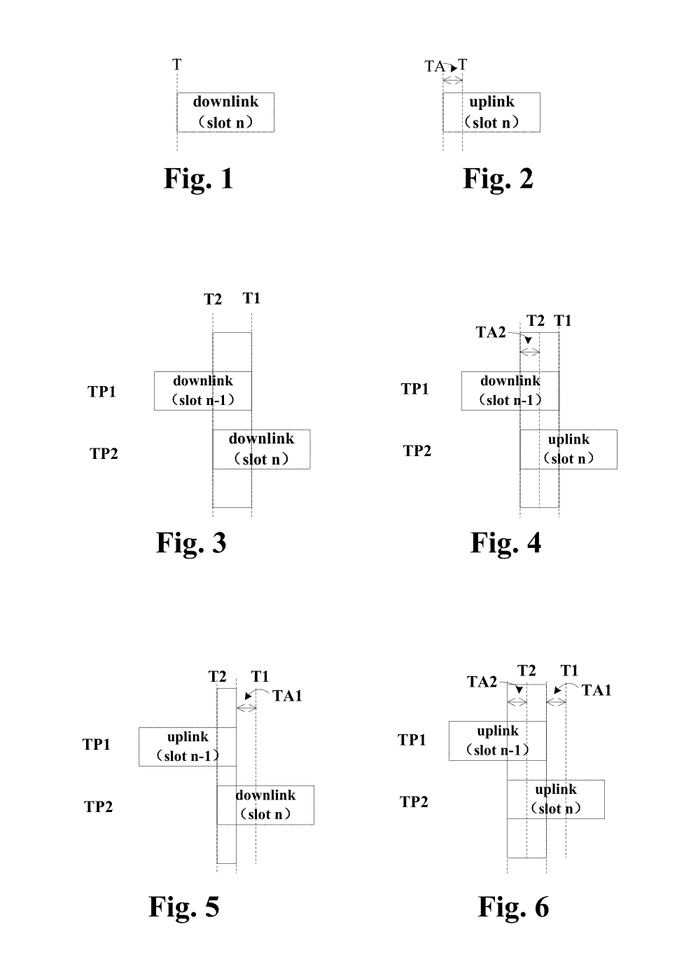

In the embodiments of this disclosure, a timing reference point of a transmission point denotes a beginning time instant of a time slot n when a terminal is receiving data from the transmission point. For example, as shown in FIG. 1, if the terminal is about to receive the downlink data from the transmission point at time slot n, the timing reference point of the transmission point for time slot n is T.

In the embodiments of this disclosure, timing advance of uplink transmission denotes that if uplink data is received at time slot n, it needs to transmit the uplink data in advance the length of time indicated by the timing advance relative to the timing reference point of the transmission point at time slot n. For example, as shown in FIG. 2, if the timing reference point of the transmission point at time slot n is T, the terminal needs to transmit the uplink data at T-TA.

Due to timing of two transmission points are asynchronized, for the terminal, a resource in communicating with a transmission point at a time slot n−1 will be overlapped with a resource in communicating with another transmission point at a time slot n. In particular, following four cases are included, and as shown in FIGS. 3-6, wherein T1 and T2 respectively denote time reference points of TP1 and TP2 at the time slot n, that is, the terminal needs to, starting from T1, receive data transmitted by TP1 at a time slot n to the terminal; likewise, the terminal needs to, starting from T2, receive data transmitted by TP2 at the time slot n to the terminal; and TA1 and TA2 respectively denote timing advance relative to the timing reference point if the terminal needs to transmit uplink data to TP1 or TP2. In FIGS. 3-6, the slot number is for the terminal.

As shown in FIG. 3, the terminal receives downlink data of TP1 at a time slot n−1, and then receives downlink data of TP2 at the time slot n. However, at the time slot n, a timing reference point of TP2 is in advance of a timing reference point of TP1, that is, for the time slot n, T1>T2 (T1−T2>0). Hence, the terminal is unable to receive data of two TPs in the shadowed area.

As shown in FIG. 4, the terminal receives downlink data of TP1 at the time slot n<1, and then transmits uplink data to TP2 at the time slot n. However, a starting time of transmitting uplink data is in advance of an ending time of receiving downlink data of TP1 at the time slot n<1 by the terminal, that is, T2−TA2<T1 (T1−T2>TA2). Hence, the terminal is only able to receive downlink data of TP1 or transmit uplink data to TP2 in the shadowed area.

As shown in FIG. 5, the terminal transmits uplink data to TP1 at the time slot n−1, and then receives downlink data of TP2 at the time slot n. However, a starting time of receiving the downlink data of TP2 is in advance of an ending time of transmitting uplink data to TP1 at the time slot n−1, that is, T2<T1−TA1 (T1−T2>TA1). Hence, the terminal may only receive downlink data of TP2 or transmit uplink data to TP1 in the shadowed area.

As shown in FIG. 6, the terminal transmits uplink data to TP1 at the time slot n−1, and then transmits uplink data to TP2 at the time slot n. However, a starting time of transmitting uplink data to TP2 at the time slot n is in advance of an ending time of transmitting uplink data to TP1 at the time slot n−1, that is, T2−TA2<T1−TA1 (T1−T2>TA1−TA2). Hence, the terminal is unable to transmit uplink data to TP1 and TP2 in the shadowed area at the same time.

In order to solve the problem of resource overlapping shown in FIGS. 3-6, embodiments of this disclosure provide a method and an apparatus for detecting and processing resource overlapping and a system, which shall be described below with reference to the accompanying drawings. However, it may be understood by those skilled in the art that the embodiments are not limited to the scenarios shown in FIGS. 3-6, and they are also applicable to other scenarios where resource overlapping is detected and processed.

### Embodiment 1

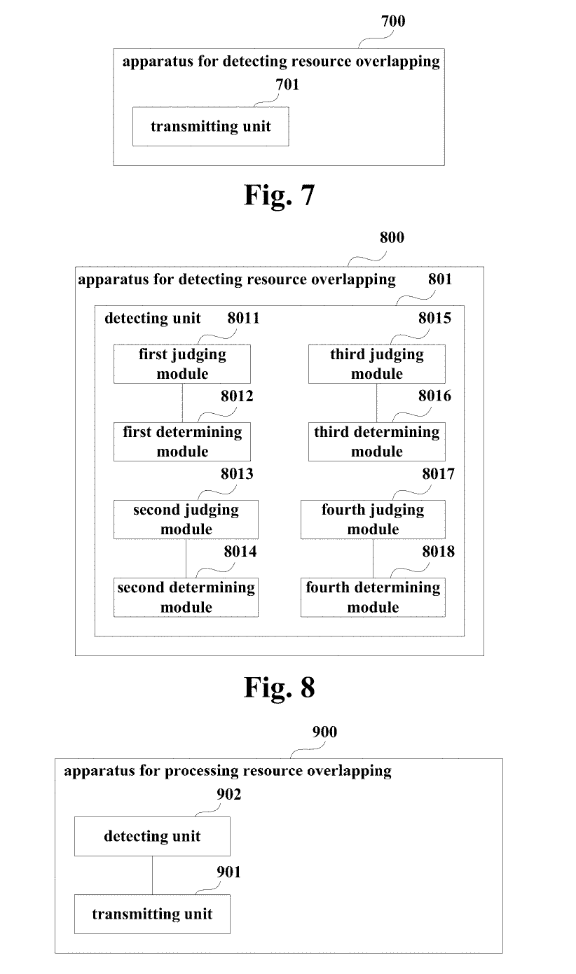

The embodiment of this disclosure provides an apparatus for detecting resource overlapping, applicable to a terminal (UE). FIG. 7 is a schematic diagram of a structure of the apparatus. As shown in FIG. 7, the apparatus 700 includes a transmitting unit 701 configured to transmit timing reference information to transmission points serving for the terminal, so that the transmission points detect whether resources allocated by them for the terminal are overlapped with resources allocated by other transmission points for the terminal according to the timing reference information.

In one implementation, the transmitting unit 701 transmits the timing reference information to one transmission point serving for the terminal. In this implementation, the timing reference information may include any piece of the following information: timing reference points of all or part of the transmission points serving for the terminal, a difference between the timing reference points of all or part of the transmission points serving for the terminal, timing advance of uplink transmission of all or part of the transmission points serving for the terminal, the timing reference points and the timing advance of uplink transmission of all or part of the transmission points serving for the terminal, and the difference between the timing reference points and the timing advance of uplink transmission of all or part of the transmission points serving for the terminal.

Taking that the terminal UE is served by two transmission points TP1 and TP2 as an example, in this implementation, the transmitting unit 701 may transmit the timing reference information to TP1 or TP2. The timing reference information may include a timing reference point T1 of TP1 and/or a timing reference point T2 of TP2, or may include a difference (T1−T2 or T2−T1) between timing reference point of TP1 and timing reference point of TP2, or may include timing advance TA1 of uplink transmission of TP1 and/or timing advance TA2 of uplink transmission of TP2, or may include a timing reference point T1 of TP1 and/or a timing reference point T2 of TP2, and the timing advance TA1 of uplink transmission of TP1 and/or timing advance TA2 of uplink transmission of TP2, or may include the difference (T1−T2 or T2−T1) between timing reference point of TP1 and timing reference point of TP2, and the timing advance TA1 of uplink transmission and/or timing advance TA2 of uplink transmission.

In this example, if TP1 and TP2 know respective TA1 and TA2, the transmitting unit 701 may transmit T1 and T2 or T1−T2/T2−T1 to TP1, then TP1 may transmit the above information received from the terminal, together with TA1 of itself, to TP2. Alternatively, TP2 may transmit TA2 of itself to TP1. Likewise, the transmitting unit 701 may transmit T1 and T2 or T1−T2/T2−T1 to TP2, then TP2 may transmit the above information received from the terminal, together with TA2 of itself, to TP1. Alternatively, TP1 may transmit TA1 of itself to TP2.

In this example, if TP1 and TP2 do not know respective TA1 and TA2, the transmitting unit 701 may transmit T1 and T2 (or T1−T2/T2−T1), and TA1 and/or TA2, to TP1, then TP1 may transmit the above information received from the terminal to TP2. Likewise, the transmitting unit 701 may transmit T1 and T2 (or T1−T2/T2−T1), and TA1 and/or TA2, to TP2, then TP2 may transmit the above information received from the terminal to TP1.

In this implementation, the difference between the timing reference points of all the transmission points serving for the terminal refers to a difference between timing reference points of any two of all the transmission points. Taking that the terminal is served by three transmission points TP1, TP2 and TP3 as an example, the difference between the timing reference points of all the transmission points refers to T1−T2/T2−T1, T1−T3/T3−T1 and T2−T3/T3−T2. Likewise, the difference between the timing reference points of part of the transmission points serving for the terminal refers to a difference between timing reference points of any two of part of the transmission points. Still taking that the terminal is served by three transmission points as an example, the difference between the timing reference points of part of the transmission points refers to T1−T2/T2−T1 and T1−T3/T3−T1, or T1−T3/T3−T1 and T2−T3/T3−T2, or T1−T2/T2−T1 and T2−T3/T3−T2.

In another implementation, the transmitting unit 701 transmits the above timing reference information to all the transmission points serving for the terminal. In this implementation, the timing reference information transmitted to one transmission point may include any piece of the following information: timing reference points of all or part of the transmission points serving for the terminal and timing advance of uplink transmission, the timing advance of uplink transmission of all or part of the transmission points serving for the terminal, and the difference between the timing reference points of all or part of the transmission points serving for the terminal and the timing advance of uplink transmission.

In this implementation, a concept of the difference between the timing reference points is identical to that described above, which shall not be described herein any further.

The terminal UE being served by two transmission points TP1 and TP2 is still taken as an example.

In this example, if TP1 and TP2 know respective TA1 and TA2, the transmitting unit 701 may transmit T1 and T2 (or T1−T2/T2−T1), and TA2, to TP1, and transmit T1 and T2 (or T1−T2/T2−T1), and TA1, to TP2.

In this example, if TP1 and TP2 do not know respective TA1 and TA2, the transmitting unit 701 may transmit T1 and T2 (or T1−T2/T2−T1), and TA1 and/or TA2, to TP1 and TP2.

In this embodiment, time slots to which the timing reference points or the timing advance of uplink transmission or the difference between the timing reference points in the timing reference information correspond(s) may be indicated by time slot indication information contained in the timing reference information, or may be pre-defined, or may be indicated in other manners, and this embodiment is not limited thereto.

With the apparatus of embodiment, when a terminal is served by multiple transmission points, the timing reference information related to the multiple transmission points is transmitted to one or more transmission points, so that the transmission points detect whether the resources allocated by them for the terminal are overlapped with the resources allocated by other transmission points for the terminal, and adopt suitable measures to avoid the overlapping, thereby solving the problem pointed out in the Background.

### Embodiment 2

The embodiment of this disclosure provides an apparatus for detecting resource overlapping, applicable to a transmission point, a concept of the transmission point being identical to that described above, which shall not be described herein any further. FIG. 8 is a schematic diagram of a structure of the apparatus. As shown in FIG. 8, the apparatus 800 includes a detecting unit 801 configured to detect whether resources allocated by the transmission point for a terminal are overlapped with resources allocated by other transmission points for the terminal according to timing reference information.

In one implementation, the timing reference information includes timing reference points of all transmission points serving for the terminal or a difference between the timing reference points of all the transmission points. And in this implementation, the detecting unit 801 includes a first judging module 8011 and a first determining module 8012.

In this implementation, the first judging module 8011 is configured to, for the same time slot (such as time slot n shown in FIG. 3), judge whether timing reference points of other transmission points (such as TP2 shown in FIG. 3) are in advance of a timing reference point of the transmission point (such as TP1 shown in FIG. 3). And the first determining module 8012 is configured to determine that resources allocated by the transmission point for the terminal are overlapped with the resources allocated by the other transmission points for the terminal when it is judged yes by the first judging module 8011.

In this implementation, the timing reference points or the difference between the timing reference points may be transmitted by the terminal, as described in Embodiment 1, or may be known by the transmission point. For example, all the transmission points serving for the terminal know timing reference points of themselves, and the transmission points may obtain the timing reference points or the difference between the timing reference points of all the transmission points by information exchange between the transmission points. Hence, the transmission point may judge via the first judging module 8011 and the first determining module 8012 whether the resources allocated by it for the terminal are overlapped with resources allocated by other transmission points of the terminal.

Taking the scenario shown in FIG. 3 as an example, if it is judged by the first judging module 8011 that T1>T2, or T1−T2=0, the first determining module 8012 determines that there exists resource overlapping.

In another implementation, the timing reference information includes timing reference points of all the transmission points serving for the terminal or a difference between the timing reference points of all the transmission points, and timing advance of uplink transmission of the transmission point (such as TP1 shown in FIG. 5). And in this implementation, as shown in FIG. 8, the detecting unit 801 may include a second judging module 8013 and a second determining module 8014.

In this implementation, the second judging module 8013 is configured to, for the same time slot (such as time slot n shown in FIG. 5), judge whether the timing reference points of other transmission points (such as TP2 shown in FIG. 5) are in advance of an uplink transmission timing of the transmission point (such as TP1 shown in FIG. 5). And the second determining module 8014 is configured to determine that the resources allocated by the transmission point for the terminal are overlapped with the resources allocated by the other transmission points for the terminal when it is judged yes by the second judging module 8013.

In this implementation, similar to the previous implementation, the timing reference points or the difference between the timing reference points may be transmitted by the terminal, or may be known by the transmission points and determined by the transmission points by information exchange, which shall not be described herein any further.

In this implementation, the timing advance of uplink transmission of the transmission point may be known by the transmission point, or may be transmitted by the terminal, or may be transmitted by another transmission point, as described in Embodiment 1. Hence, the transmission point may further judge via the second judging module 8013 and the second determining module 8014 whether the resources allocated by it for the terminal are overlapped with resources allocated by other transmission points for the terminal.

Taking the scenario shown in FIG. 5 as an example, if it is judged by the second judging module 8013 that T2<T1−TA1, i.e., T2−T1<−TA1, or T1−T2>TA1, the second determining module 8014 determines that there exists resource overlapping.

In another implementation, the timing reference information includes timing reference points of all the transmission points serving for the terminal or a difference between the timing reference points of all the transmission points, and timing advance of uplink transmission of another transmission point (such as TP2 shown in FIG. 4). And in this implementation, as shown in FIG. 8, the detecting unit 801 may include a third judging module 8015 and a third determining module 8016.

In this implementation, the third judging module 8015 is configured to, for the same time slot (such as time slot n shown in FIG. 4), judge whether the uplink transmission timing of other transmission points (such as TP2 shown in FIG. 4) is in advance of a timing reference point of the transmission point (such as TP1 shown in FIG. 4). And the third determining module 8016 is configured to determine that the resources allocated by the transmission point for the terminal are overlapped with the resources allocated by the other transmission points for the terminal when it is judged yes by the third judging module 8015.

In this implementation, similar to the previous implementation, the timing reference points or the difference between the timing reference points may be transmitted by the terminal, or may be known by the transmission points and determined by the transmission points by information exchange, which shall not be described herein any further.

In this implementation, the timing advance of uplink transmission of the other transmission points may be transmitted by the other transmission points, or may be transmitted by the terminal, as described in Embodiment 1. Hence, the transmission point may further judge via the third judging module 8015 and the third determining module 8016 whether the resources allocated by it for the terminal are overlapped with resources allocated by the other transmission points for the terminal.

Taking the scenario shown in FIG. 4 as an example, if it is judged by the third judging module 8015 that T2−TA2<T1, that is, T2−T1<TA2, or T1−T2>−TA2, the third determining module 8016 determines that there exists resource overlapping.

In another implementation, the timing reference information includes timing reference points of all the transmission points serving for the terminal or a difference between the timing reference points of all the transmission points, and timing advance of uplink transmission of all the transmission points. And in this implementation, as shown in FIG. 8, the detecting unit 801 may include a fourth judging module 8017 and a fourth determining module 8018.

In this implementation, the fourth judging module 8017 is configured to, for the same time slot (such as time slot n shown in FIG. 6), judge whether an uplink transmission timing of the other transmission points (such as TP2 shown in FIG. 6) is in advance of the uplink transmission timing of the transmission point (such as TP1 shown in FIG. 6). And the fourth determining module 8018 is configured to determine that the resources allocated by the transmission point for the terminal are overlapped with resources allocated by the other transmission points for the terminal when it is judged yes by the fourth judging module 8017.

In this implementation, similar to the previous implementation, the timing reference points or the difference between the timing reference points may be transmitted by the terminal, or may be known by the transmission points and determined by the transmission points by information exchange, which shall not be described herein any further.

In this implementation, in the timing advance of uplink transmission of all the transmission points, the timing advance of uplink transmission of the transmission points may be known by the transmission point, or may be transmitted by the terminal, and the timing advance of uplink transmission of the other transmission points may be transmitted by the other transmission points, or may be transmitted by the terminal, as described in Embodiment 1. Hence, the transmission point may further judge via the fourth judging module 8017 and the fourth determining module 8018 whether the resources allocated by it for the terminal are overlapped with resources allocated by the other transmission points for the terminal.

Taking the scenario shown in FIG. 6 as an example, if it is judged by the fourth judging module 8017 that T2−TA2<T1−TA1, i.e., T2−T1<TA2−TA1, or T1−T2>TA1−TA2, the fourth determining module 8018 determines that there exists resource overlapping.

In this embodiment, the above fourth implementations may be merged or may be arbitrarily combined, and are not limited to the combinations shown FIG. 8.

In this embodiment, similar to Embodiment 1, time slots to which the timing reference points or the timing advance of uplink transmission or the difference between the timing reference points contained in the timing reference information correspond(s) may be indicated by time slot indication information contained in the timing reference information, or may be pre-defined, or may be indicated in other manners, and this embodiment is not limited thereto.

With the apparatus of this embodiment, the transmission points may detect according to the timing reference information whether the resources allocated by them for the terminal are overlapped with the resources allocated by the other transmission points for the terminal, so as to adopt suitable measures to avoid the overlapping, thereby solving the problem pointed out in the Background.

### Embodiment 3

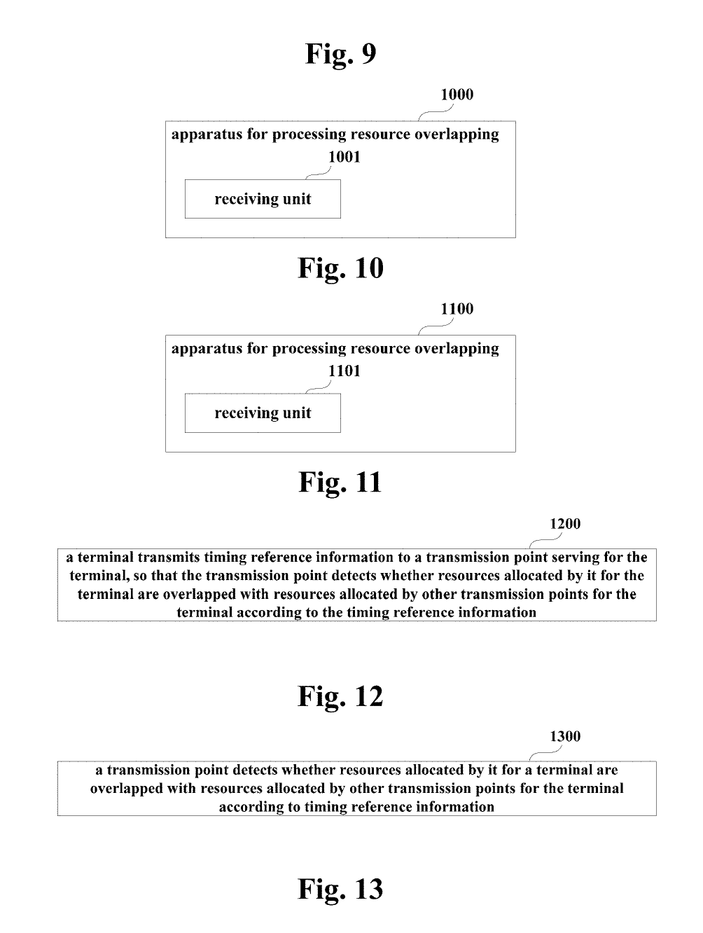

The embodiment of this disclosure provides an apparatus for processing resource overlapping, applicable to a transmission point, a concept of the transmission point being identical to that described above, which shall not be described herein any further. FIG. 9 is a schematic diagram of a structure of the apparatus. As shown in FIG. 9, the apparatus 900 includes a transmitting unit 901 configured to transmit indication information to other transmission points or a terminal, the indication information being used to indicate that resources allocated by the transmission point for the terminal are overlapped with resources allocated by the other transmission points for the terminal, and/or a scheduling scheme (or an allocation scheme) of overlapped resources.

In this embodiment, the transmission point and the other transmission points jointly serve for the terminal.

In one implementation of the transmitting unit 901, when the transmission point detects that the resources allocated by it for the terminal are overlapped with resources allocated by the other transmission points for the terminal, the transmission point notifies such a case to the other transmission points or the terminal via the indication information. Hence, the other transmission points or the terminal may adopt avoidance measures accordingly.

In another implementation of the transmitting unit 901, when the transmission point detects that the resources allocated by it for the terminal are overlapped with resources allocated by the other transmission points for the terminal, the transmission point notifies the scheduling scheme (or the allocation scheme) of overlapped resources to the other transmission points or the terminal via the indication information. Hence, the other transmission points or the terminal may adopt avoidance measures accordingly.

For example, the indication information may indicate the following contents: the transmission point or the other transmission points doing not schedule the same terminal in an overlapped time slot.

Stilling taking that the terminal is served by two transmission points, TP1 and TP2, as an example, in this implementation, TP1 may transmit indication information to TP2 showing that TP1 does not schedule the terminal at a time slot n−1, or suggesting TP2 not to schedule the terminal at the time slot n. Correspondingly, TP1 may further transmit indication information to the terminal showing that the terminal will not be scheduled at the time slot n−1 by TP1, or transmit indication information to the terminal showing that the terminal will not be scheduled at the time slot n by TP2.

Likewise, TP2 may transmit indication information to TP1 showing that TP2 does not schedule the terminal at the time slot n, or suggesting TP1 not to schedule the terminal at a time slot n−1. Correspondingly, TP2 may further transmit indication information to the terminal showing that the terminal will not be scheduled at the time slot n by TP2, or transmit indication information to the terminal showing that the terminal will not be scheduled at the time slot n−1 by TP1.

In the example here, a transmission point not scheduling the terminal in the overlapped time slot may be determined by default by setting priorities of the transmission points. For example, transmission points with lower priorities do not schedule the terminal in the overlapped time slot.

For another example, the indication information may indicate the following contents: the transmission point or the other transmission points will advance or postpone a predetermined time to schedule the same terminal to communicate with the transmission point or the other transmission points at an overlapped time slot.

Stilling taking that the terminal is served by two transmission points, TP1 and TP2, as an example, in this implementation, TP1 may transmit indication information to TP2 showing TP1 will advance a time t to schedule the terminal to communicate with TP1 at the time slot n−1, or transmit indication information suggesting TP2 to postpone a time t to schedule the terminal to communicate with TP2 at the time slot n. Correspondingly, TP1 or TP2 may transmit corresponding information to the terminal showing such an action.

Likewise, TP2 may transmit indication information to TP1 showing that TP2 will postpone a time t to schedule the terminal to communicate with TP2 at the time slot n, or transmit indication information suggesting TP1 to advance a time t to schedule the terminal to communicate with TP1 at the time slot n−1. Correspondingly, TP1 or TP2 may transmit corresponding information to the terminal showing such an action.

In this example, the above advancing/postponing may be achieved by changing a length of a guard time (GT) for conversion between uplink transmission and downlink transmission, or may be achieved by presetting a fixed time length, and this embodiment is not limited thereto.

In this example, a transmission point advancing or postponing the above predetermined time to schedule the terminal may be determined by default by setting priorities of the transmission points. For example, transmission points with lower priorities postpone the above predetermined time.

For a further example, the indication information may indicate the following contents: the transmission point or the other transmission points doing not allocate resources for the same terminal in a coincided area of an overlapped time slot. Hence, the terminal may communicate with the other transmission points or the transmission point within the whole overlapped time slot.

Stilling taking that the terminal is served by two transmission points, TP1 and TP2, as an example, in this implementation, TP1 may transmit indication information to TP2 showing that TP1 will not allocate resources for the terminal at some resource positions within the time slot n−1, or transmit indication information suggesting TP2 to allocate resources for the terminal within the whole time slot n, so that the terminal may communicate with TP2 within the whole time slot n. Correspondingly, TP1 or TP2 may transmit indication information to the terminal showing that the terminal may communicate with TP2 within the whole time slot n, or transmit indication information showing that TP1 will not allocate resources for the terminal at some areas within the time slot n−1, hence, the terminal will not communicate with TP1 within the areas.

Likewise, TP2 may transmit indication information to TP1 showing that TP2 will not allocate resources for the terminal at some resource positions within the time slot n, or transmit indication information suggesting TP1 to allocate resources for the terminal within the whole time slot n−1, so that the terminal may communicate with TP1 within the whole time slot n−1. Correspondingly, TP1 or TP2 may transmit indication information to the terminal showing that the terminal may communicate with TP1 within the whole time slot n−1, or transmit indication information showing that TP2 will not allocate resources for the terminal at some areas within the time slot n, hence, the terminal will not communicate with TP2 within the areas.

In this implementation, if the transmission point and the other transmission points serve for a downlink of the terminal on the overlapped resources at the same time, the indication information may indicate the following contents: the transmission point and the other transmission points transmitting identical or different data to the terminal.

Stilling taking that the terminal is served by two transmission points, TP1 and TP2, as an example, if TP1 and TP2 serve for the downlink of the terminal on the overlapped resources at the same time, the two transmission points may transmit identical or different data to the terminal, and the data may be superimposed on the overlapped resources for transmission, and may be differentiated by different transmission power, and this embodiment is not limited thereto. In this example, TP1 or TP2 may show such an action by transmitting the above indication information to TP2 or TP1. And in this example, TP1 or TP2 may further transmit the above indication information to the terminal to show such an action.

In this implementation, if the transmission point and the other transmission points serve for an uplink of the same terminal on the overlapped resources at the same time, the indication information may indicate the following contents: the terminal may transmit identical or different data to the transmission point and the other transmission points at the same time.

Similar to the above example, if TP1 and TP2 serve for the uplink of the terminal on the overlapped resources at the same time, the terminal may transmit identical or different data to the two transmission points at the same time, and the data may be superimposed on the overlapped resources for transmission, and may be differentiated by different transmission power, and this embodiment is not limited thereto. In this example, TP1 or TP2 may show such an action by transmitting the above indication information to TP2 or TP1, and may further transmit the above indication information to the terminal to show such an action.

The measures adopted by the transmission points when there exists resource overlapping are described above by way of implementations and examples; however, this embodiment is not limited thereto, and any measures where transmission points may show such overlapping and/or avoid such overlapping by transmitting the above indication information are covered by the protection scope of this application.

In this embodiment, the method for detecting resource overlapping by the transmission points is not limited to that provided in Embodiment 2.

In one implementation, as shown in FIG. 9, the apparatus may further include a detecting unit 902 configured to detect whether resources allocated by the transmission point for the terminal are overlapped with resources allocated by the other transmission points for the terminal.

In one implementation of the detecting unit 902, the detecting unit 902 may perform the above detection according to timing reference information. The timing reference information and the method for detecting the same have been described in Embodiment 2, the contents of which being incorporated herein, which shall not be described herein any further.

In another implementation of the detecting unit 902, the detecting unit 902 may perform the above detection according to other information, which shall not be described herein any further.

With the apparatus of this embodiment, when resource overlapping is detected, the transmission points may adopt suitable measures to avoid the overlapping, thereby solving the problem pointed out in the Background.

### Embodiment 4

The embodiment of this disclosure provides an apparatus for processing resource overlapping, applicable to a terminal, which is processing at the terminal side corresponding to Embodiment 3, with contents identical to those in Embodiment 3 being not going to be described herein any further. FIG. 10 is a schematic diagram of a structure of the apparatus. As shown in FIG. 10, the apparatus 1000 includes a receiving unit 1001 configured to receive indication information transmitted by a transmission point, the indication information being used to indicate that resources allocated by the transmission point for the terminal are overlapped with resources allocated by other transmission points for the terminal, and/or a scheduling scheme (an allocation scheme) of the overlapped resources.

In this embodiment, the terminal is served by the transmission point and the other transmission points jointly.

In this embodiment, with the above indication information, the terminal may obtain information about time slots where there exists resource overlapping, and/or a scheduling scheme (an allocation scheme) of the overlapped resources. Hence, the terminal may learn time slots where it is scheduled and a transmission point or transmission points by which it is scheduled, so as to perform corresponding data reception and transmission, thereby avoiding performance degradation caused by resource overlapping.

### Embodiment 5

The embodiment of this disclosure provides an apparatus for processing resource overlapping, applicable to a transmission point, which is processing at the other transmission points side corresponding to Embodiment 3, with contents identical to those in Embodiment 3 being not going to be described herein any further. FIG. 11 is a schematic diagram of a structure of the apparatus. As shown in FIG. 11, the apparatus 1100 includes a receiving unit 1101 configured to receive indication information transmitted by another transmission point (that is the transmission point in Embodiment 3), the indication information being used to indicate that resources allocated by another transmission point for the terminal are overlapped with resources allocated by the transmission point for the terminal, and/or a scheduling scheme (an allocation scheme) of the overlapped resources;

In this embodiment, the terminal is served by the transmission point and another transmission point jointly.

In this embodiment, with the above indication information, the terminal may obtain information about time slots where there exists resource overlapping, and/or a scheduling scheme (an allocation scheme) of the overlapped resources. Hence, the transmission point may adopt corresponding measure to avoid overlapping, such as not scheduling the terminal at overlapped time slots, or scheduling the terminal at overlapped time slots by advancing or postponing a predetermined time, or not scheduling the terminal in a coincided area of overlapped time slots, thereby avoiding performance degradation due to resource overlapping.

### Embodiment 6

The embodiment of this disclosure provides a method for detecting resource overlapping, applicable to a terminal. As principles of the method for solving problems are similar to that of the apparatus of Embodiment 1, the implementation of the apparatus of Embodiment 1 may be referred to for implementation of the method, with identical contents being not going to be described herein any further. FIG. 12 is a flowchart of the method. As shown in FIG. 12, the method includes:

step 1200: a terminal transmits timing reference information to a transmission point serving for the terminal, so that the transmission point detects whether resources allocated by it for the terminal are overlapped with resources allocated by other transmission points for the terminal according to the timing reference information.

In one implementation, the terminal transmits the timing reference information to one transmission point serving for the terminal, and the timing reference information may include: timing reference points of all or part of the transmission points serving for the terminal, or a difference between the timing reference points of all or part of the transmission points serving for the terminal, or timing advance of uplink transmission of all or part of the transmission points serving for the terminal, or the timing reference points and the timing advance of uplink transmission of all or part of the transmission points serving for the terminal, or the difference between the timing reference points and the timing advance of uplink transmission of all or part of the transmission points serving for the terminal.

In another implementation, the terminal transmits the timing reference information to all the transmission points serving for the terminal, and the timing reference information transmitted to one transmission point may include: timing reference points of all or part of the transmission points serving for the terminal and timing advance of uplink transmission, or the timing advance of uplink transmission of all or part of the transmission points serving for the terminal, or the difference between the timing reference points of all or part of the transmission points serving for the terminal and the timing advance of uplink transmission.

In this embodiment, time slots to which the timing reference points or the timing advance of uplink transmission or the difference between the timing reference points in the timing reference information correspond(s) are indicated by time slot indication information contained in the timing reference information, or are pre-defined.

With the method of this embodiment, the timing reference information is transmitted to the transmission points, and the transmission points are assisted in detecting resource overlapping, thereby solving the problem pointed out in the Background, and ensuring performance of the terminal.

### Embodiment 7

The embodiment of this disclosure provides a method for detecting resource overlapping, applicable to a transmission point. As principles of the method for solving problems are similar to that of the apparatus of Embodiment 2, the implementation of the apparatus of Embodiment 2 may be referred to for implementation of the method, with identical contents being not going to be described herein any further. FIG. 13 is a flowchart of the method. As shown in FIG. 13, the method includes:

step 1300: a transmission point detects whether resources allocated by it for a terminal are overlapped with resources allocated by other transmission points for the terminal according to timing reference information.

In one implementation, the timing reference information includes timing reference points of all transmission points serving for the terminal or a difference between the timing reference points of the transmission points. Hence, in step 1300, the transmission point may, for the same time slot, judge whether timing reference points of other transmission points are in advance of a timing reference point of the transmission point, and determine that resources allocated by the transmission point for the terminal are overlapped with the resources allocated by the other transmission points for the terminal when it is judged yes.

In another implementation, the timing reference information includes timing reference points of all the transmission points serving for the terminal or a difference between the timing reference points of all the transmission points, and timing advance of uplink transmission of the transmission point. Hence, in step 1300, the transmission point may, for the same time slot, judge whether the timing reference points of other transmission points are in advance of an uplink transmission timing of the transmission point, and determine that the resources allocated by the transmission point for the terminal are overlapped with the resources allocated by the other transmission points for the terminal when it is judged yes.

In a further implementation, the timing reference information includes timing reference points of all the transmission points serving for the terminal or a difference between the timing reference points of all the transmission points, and timing advance of uplink transmission of the other transmission points. Hence, in step 1300, the transmission point may, for the same time slot, judge whether an uplink transmission timing of the other transmission points is in advance of the timing reference point of the transmission point, and determine that the resources allocated by the transmission point for the terminal are overlapped with the resources allocated by the other transmission points for the terminal when it is judged yes.

In still another implementation, the timing reference information includes timing reference points of all the transmission points serving for the terminal or a difference between the timing reference points of all the transmission points, and timing advance of uplink transmission of all the transmission points. Hence, in step 1300, the transmission point may, for the same time slot, judge whether an uplink transmission timing of the other transmission points is in advance of the uplink transmission timing of the transmission point, and determine that the resources allocated by the transmission point for the terminal are overlapped with the resources allocated by the other transmission points for the terminal when it is judged yes.

In the above implementations, the timing reference points of all the transmission points serving for the terminal or the difference between the timing reference points of all the transmission points may be transmitted by the terminal, or may be transmitted by the transmission points; the timing advance of the uplink transmission of the transmission point may be transmitted by the terminal, or may be known by the transmission point; the timing advance of the uplink transmission of the other transmission points may be transmitted by the terminal, or may be transmitted by the other transmission points; and in the timing advance of the uplink transmission of all the transmission points, the timing advance of the uplink transmission of the transmission point may be known by the transmission point, or may be transmitted by the terminal, and the timing advance of the uplink transmission of the other transmission points may be transmitted by the other transmission points, or may be transmitted by the terminal, details being as described in Embodiment 2, and being not going to be described herein any further.

In this embodiment, time slots to which the timing reference points or the timing advance of uplink transmission or the difference between the timing reference points in the timing reference information correspond(s) are indicated by time slot indication information contained in the timing reference information, or are pre-defined.

With the method of this embodiment, the transmission point may detect according to the timing reference information whether the resources allocated by it for the terminal are overlapped with the resources allocated by the other transmission points for the terminal, and adopt suitable measures to avoid the overlapping, thereby ensuring performance of the terminal.

### Embodiment 8

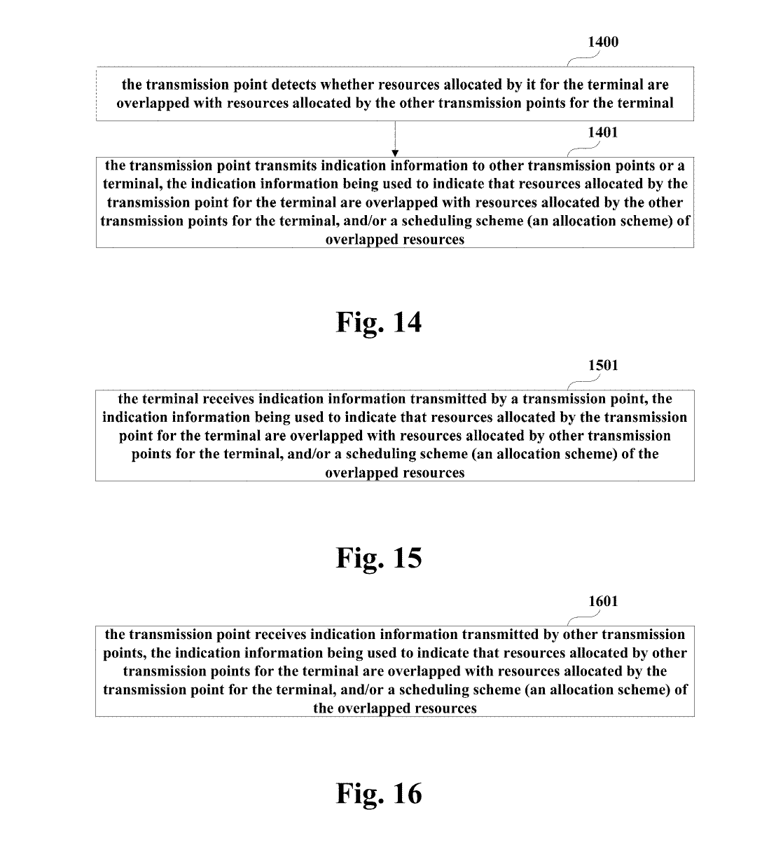

The embodiment of this disclosure provides a method for processing resource overlapping, applicable to a transmission point. As principles of the method for solving problems are similar to that of the apparatus of Embodiment 3, the implementation of the apparatus of Embodiment 3 may be referred to for implementation of the method, with identical contents being not going to be described herein any further. FIG. 14 is a flowchart of the method. As shown in FIG. 14, the method includes:

step 1401: the transmission point transmits indication information to other transmission points or a terminal, the indication information being used to indicate that resources allocated by the transmission point for the terminal are overlapped with resources allocated by the other transmission points for the terminal, and/or a scheduling scheme (an allocation scheme) of overlapped resources; wherein, the transmission point and the other transmission points jointly serve for the terminal.

In one implementation, the indication information is used to indicate that the transmission point or the other transmission points do not schedule the same terminal in an overlapped time slot.

In another implementation, the indication information is used to indicate that the transmission point or the other transmission points may advance or postpone a predetermined time to schedule the same terminal to communicate with the transmission point or the other transmission points in an overlapped time slot.

In a further implementation, the indication information is used to indicate that the transmission point or the other transmission points do not allocate resources for the same terminal in a coincided area of an overlapped time slot.

In still another implementation, if the transmission point and the other transmission points serve for a downlink of the same terminal on the overlapped resources at the same time, the indication information is used to indicate that the transmission point and the other transmission points transmit identical or different data to the terminal.

In yet another implementation, if the transmission point and the other transmission points serve for an uplink of the same terminal on the overlapped resources at the same time, the indication information is used to indicate that the terminal may transmit identical or different data to the transmission point and the other transmission points at the same time.

In this embodiment, alternatively, the method may further include:

step 1400: the transmission point detects whether resources allocated by it for the terminal are overlapped with resources allocated by the other transmission points for the terminal.

In this embodiment, the transmission point may detect whether the resources allocated by it for the terminal are overlapped with the resources allocated by the other transmission points for the terminal according to timing reference information, and Embodiment 2 may be referred to for a particular detection method, which shall not be described herein any further.

The above method for detecting resource overlapping according to the timing reference information is illustrative only, and this embodiment is not limited thereto.

With the method of this embodiment, the transmission point may transmit the above indication information to the other transmission points and/or the terminal when it detects that the resources allocated by it for the terminal are overlapped with the resource allocated by the other transmission points for the terminal, so as to perform processing avoiding the overlapping, thereby ensuring performance of the terminal.

### Embodiment 9

The embodiment of this disclosure provides a method for processing resource overlapping, applicable to a terminal. As principles of the method for solving problems are similar to that of the apparatus of Embodiment 4, the implementation of the apparatus of Embodiment 4 may be referred to for implementation of the method, with identical contents being not going to be described herein any further. FIG. 15 is a flowchart of the method. As shown in FIG. 15, the method includes:

step 1501: the terminal receives indication information transmitted by a transmission point, the indication information being used to indicate that resources allocated by the transmission point for the terminal are overlapped with resources allocated by other transmission points for the terminal, and/or a scheduling scheme (an allocation scheme) of the overlapped resources; wherein, the transmission point and the other transmission points jointly serve for the terminal.

With the method of this embodiment, the terminal performs corresponding processing according to the received indication information and the contents indicated by the indication information, such as not receiving or transmission data at time slots that are not scheduled, thereby ensuring performance of the terminal.

### Embodiment 10

The embodiment of this disclosure provides a method for processing resource overlapping, applicable to a transmission point. As principles of the method for solving problems are similar to that of the apparatus of Embodiment 5, the implementation of the apparatus of Embodiment 5 may be referred to for implementation of the method, with identical contents being not going to be described herein any further. FIG. 16 is a flowchart of the method. As shown in FIG. 16, the method includes:

step 1601: the transmission point receives indication information transmitted by other transmission points, the indication information being used to indicate that resources allocated by other transmission points for the terminal are overlapped with resources allocated by the transmission point for the terminal, and/or a scheduling scheme of the overlapped resources; wherein, the transmission point and the other transmission points jointly serve for the terminal.

With the method of this embodiment, the transmission point may perform corresponding processing according to the received indication information and the contents indicated by the indication information, such as not scheduling the terminal at overlapped time slots, or scheduling the terminal by advancing or postponing a predetermined time, or not allocating resources for the terminal in a coincided area of overlapped time slots, thereby ensuring performance of the terminal.

### Embodiment 11

The embodiment of this disclosure provides a transmission point device, such as a base station, including the apparatus as described in Embodiment 2, or 3, or 5.

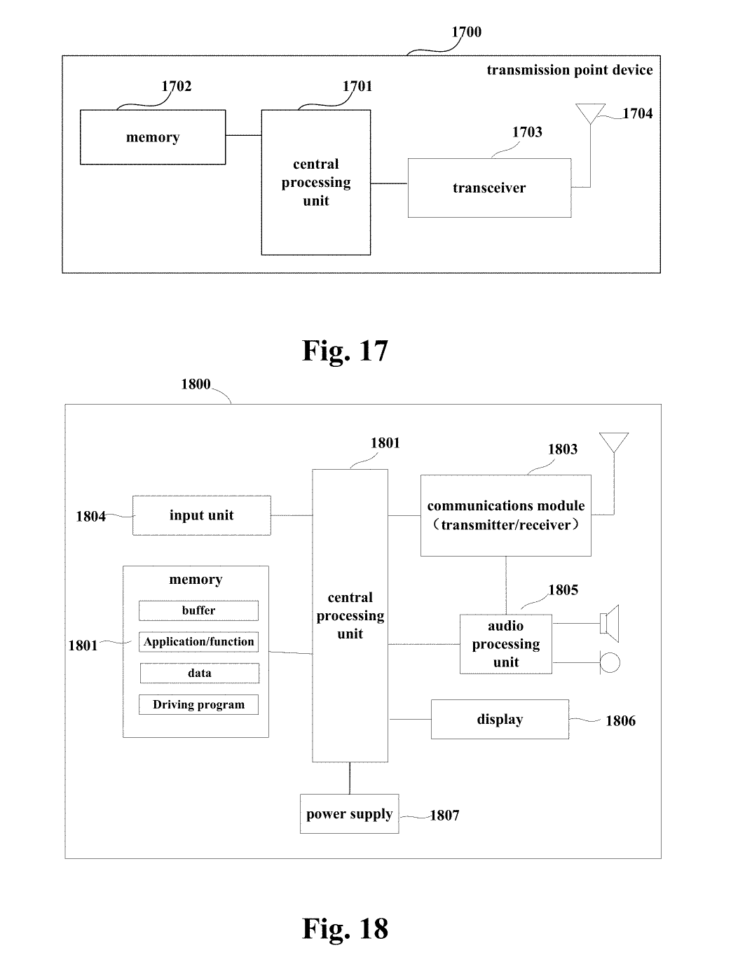

FIG. 17 is a schematic diagram of a structure of the transmission point device of the embodiment of this disclosure. As shown in FIG. 17, the transmission point device 1700 may include a central processing unit (CPU) 1701 and a memory 1702, the memory 1702 being coupled to the central processing unit 1701, wherein, the memory 1702 may store various data, and furthermore, it may store a program for information processing, and execute the program under control of the central processing unit 1701, so as to receive various information transmitted by the terminal or other transmission points, and transmit various information to the terminal or other transmission points.

In one implementation, the functions of the apparatus as described in Embodiment 2, or 3, or 5, may be integrated into the central processing unit 1701.

In another implementation, the apparatus as described in Embodiment 2, or 3, or 5 and the central processing unit 1701 may be configured separately. For example, the apparatus as described in Embodiment 2, or 3, or 5 may be configured as a chip connected to the central processing unit 1701, with its functions being realized under control of the central processing unit 1701.

Furthermore, as shown in FIG. 17, the transmission point device 1700 may further include a transceiver 1703, and an antenna 1704, etc., wherein, functions of the above components are similar to those in the relevant art, and shall not be described herein any further. It should be noted that the transmission point device 1700 does not necessarily include all the parts shown in FIG. 17, and furthermore, the transmission point device 1700 may include parts not shown in FIG 17, and the relevant art may be referred to.

With the transmission point device of this embodiment, resource overlapping may be detected, or corresponding processing may be performed when the resource overlapping is detected, thereby ensuring performance of the terminal.

### Embodiment 12

The embodiment of this disclosure provides UE, including the apparatus as described in Embodiment 1 or 4.

FIG. 18 is a schematic diagram of a systematic structure of the UE of the embodiment of this disclosure. As shown in FIG. 18, the UE 1800 may include a central processing unit 1801 and a memory 1802, the memory 1802 being coupled to the central processing unit 1801. It should be noted that this figure is illustrative only, and other types of structures may also be used, so as to supplement or replace this structure and achieve a telecommunications function or other functions.

In an implementation, the functions of the apparatus described in Embodiment 1 or 4 may be integrated into the central processing unit 1801.

In another implementation, the apparatus described in Embodiment 1 or 4 and the central processing unit 1801 may be configured separately. For example, the apparatus described in Embodiment 1 or 4 may be configured as a chip connected to the central processing unit 1801, with its functions being realized under control of the central processing unit 1801.

As shown in FIG. 18, the UE 1800 may further include a communications module 1803, an input unit 1804, an audio processing unit 1805, a display 1806 and a power supply 1807. It should be noted that the UE 1800 does not necessarily include all the parts shown in FIG. 18, and the above components are not necessary; and furthermore, the UE 1800 may include parts not shown in FIG. 18, and the relevant art may be referred to.

As shown in FIG. 18, the central processing unit 1801 is sometimes referred to as a controller or control, and may include a microprocessor or other processor devices and/or logic devices. The central processing unit 1801 receives input and controls operations of every components of the UE 1800.

In this embodiment, the memory 1802 may be, for example, one or more of a buffer memory, a flash memory, a hard drive, a mobile medium, a volatile memory, a nonvolatile memory, or other suitable devices, which may store contents relating to the above timing reference information, and may further store a program executing related information. And the central processing unit 1801 may execute the program stored in the memory 1802, so as to realize information storage or processing, etc. Functions of other parts are similar to those of the relevant art, which shall not be described herein any further. The parts of the UE 1800 may be realized by specific hardware, firmware, software, or any combination thereof, without departing from the scope of the present disclosure.

With the UE of this embodiment, the timing reference information is transmitted to the transmission points, and the transmission points are assisted in detecting resource overlapping, and corresponding processing is performed according to the indication of the transmission points, thereby ensuring performance of the terminal.

### Embodiment 13

The embodiment of this disclosure provides a communications system, including the transmission point device described in Embodiment 11 and the UE described in Embodiment 12.

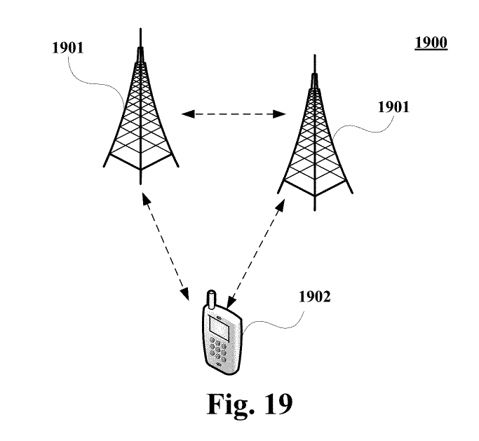

FIG. 19 is a schematic diagram of a structure of the communications system of the embodiment of this disclosure. As shown in FIG. 19, the communications system 1900 includes a base station 1901 and UE 1902, wherein, the base station 1901 may be the transmission point device 1700 described in Embodiment 11, and the UE 1902 may be the UE 1800 described in Embodiment 12. As the transmission point device 1700 and the UE 1800 have been described in detail, the contents of them are incorporated herein, which shall not be described herein any further.

With the communications system of this embodiment, resource overlapping may be avoided, and performance of the terminal may be ensured.

An embodiment of the present disclosure further provides a computer readable program, which, when executed in an apparatus for detecting or processing resource overlapping or UE, will cause a computer unit to carry out the method described in Embodiment 6 or 9 in the apparatus for detecting or processing resource overlapping or the UE.

An embodiment of the present disclosure further provides a computer storage medium, including a computer readable program, which will cause a computer unit to carry out the method described in Embodiment 6 or 9 in an apparatus for detecting or processing resource overlapping or UE.

An embodiment of the present disclosure further provides a computer readable program, which, when executed in an apparatus for detecting or processing resource overlapping or a transmission point device, will cause a computer unit to carry out the method described in Embodiment 7, or 8, or 10, in the apparatus for detecting or processing resource overlapping or the transmission point device.

An embodiment of the present disclosure further provides a computer storage medium, including a computer readable program, which will cause a computer unit to carry out the method described in Embodiment 7, or 8, or 10, in an apparatus for detecting or processing resource overlapping or a transmission point device.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for detecting resource overlapping, applicable to a terminal (UE), the apparatus comprising:
a transmitting unit configured to transmit timing reference information to a transmission point serving for the terminal, so that the transmission point detect whether resources allocated by it for the terminal are overlapped with resources allocated by other transmission points for the terminal according to the timing reference information.

2. The apparatus according to claim 1, wherein the transmitting unit transmits the timing reference information to one transmission point serving for the terminal;
and wherein, the timing reference information comprises:
timing reference points of all or part of the transmission points serving for the terminal; or
a difference between the timing reference points of all or part of the transmission points serving for the terminal; or
timing advance of uplink transmission of all or part of the transmission points serving for the terminal; or
the timing reference points and the timing advance of uplink transmission of all or part of the transmission points serving for the terminal; or
the difference between the timing reference points and the timing advance of uplink transmission of all or part of the transmission points serving for the terminal.

3. The apparatus according to claim 1, wherein the transmitting unit transmits the timing reference information to all the transmission points serving for the terminal;
and wherein, the timing reference information transmitted by the transmitting unit to one transmission point comprises:
timing reference points and the timing advance of uplink transmission of all or part of the transmission points serving for the terminal; or
the timing advance of uplink transmission of all or part of the transmission points serving for the terminal; or
the difference between the timing reference points and the timing advance of uplink transmission of all or part of the transmission points serving for the terminal.

4. The apparatus according to claim 1, wherein time slots to which the timing reference points or the timing advance of uplink transmission or the difference between the timing reference points in the timing reference information correspond(s) are indicated by time slot indication information contained in the timing reference information, or are pre-defined.

5. An apparatus for detecting resource overlapping, applicable to a transmission point, the apparatus comprising:
a detecting unit configured to detect whether resources allocated by the transmission point for a terminal are overlapped with resources allocated by other transmission points for the terminal according to timing reference information.

6. The apparatus according to claim 5, wherein the timing reference information comprises timing reference points of all transmission points serving for the terminal or a difference between the timing reference points of all the transmission points, and the detecting unit comprises:
a first judging module configured to, for the same time slot, judge whether timing reference points of other transmission points are in advance of a timing reference point of the transmission point; and
a first determining module configured to determine that resources allocated by the transmission point for the terminal are overlapped with the resources allocated by the other transmission points for the terminal when it is judged yes by the first judging module.

7. The apparatus according to claim 5, wherein the timing reference information comprises timing reference points of all the transmission points serving for the terminal or a difference between the timing reference points of all the transmission points, and timing advance of uplink transmission of the transmission point, and the detecting unit further comprises:
a second judging module configured to, for the same time slot, judge whether the timing reference points of other transmission points are in advance of an uplink transmission timing of the transmission point; and
a second determining module configured to determine that the resources allocated by the transmission point for the terminal are overlapped with the resources allocated by the other transmission points for the terminal when it is judged yes by the second judging module.

8. The apparatus according to claim 5, wherein the timing reference information comprises timing reference points of all the transmission points serving for the terminal or a difference between the timing reference points of all the transmission points, and timing advance of uplink transmission of the other transmission points, and the detecting unit comprises:
a third judging module configured to, for the same time slot, judge whether an uplink transmission timing of the other transmission points is in advance of the timing reference point of the transmission point; and
a third determining module configured to determine that the resources allocated by the transmission point for the terminal are overlapped with the resources allocated by the other transmission points for the terminal when it is judged yes by the third judging module.

9. The apparatus according to claim 5, wherein the timing reference information comprises timing reference points of all the transmission points serving for the terminal or a difference between the timing reference points of all the transmission points, and timing advance of uplink transmission of all the transmission points, and the detecting unit comprises:
a fourth judging module configured to, for the same time slot, judge whether an uplink transmission timing of the other transmission points is in advance of the uplink transmission timing of the transmission point; and
a fourth determining module configured to determine that the resources allocated by the transmission point for the terminal are overlapped with the resources allocated by the other transmission points for the terminal when it is judged yes by the fourth judging module.

10. The apparatus according to claim 5, wherein time slots to which the timing reference points or the timing advance of uplink transmission or the difference between the timing reference points in the timing reference information correspond(s) are indicated by time slot indication information contained in the timing reference information, or are pre-defined.

11. An apparatus for processing resource overlapping, applicable to a transmission point, the apparatus comprising:
a transmitting unit configured to transmit indication information to other transmission points or a terminal, the indication information being used to indicate that resources allocated by the transmission point for the terminal are overlapped with resources allocated by the other transmission points for the terminal, and/or a scheduling scheme of overlapped resources;
wherein, the transmission point and the other transmission points jointly serve for the terminal.

12. The apparatus according to claim 11, wherein,
the indication information is used to indicate that the transmission point or the other transmission points do not schedule the same terminal in an overlapped time slot.

13. The apparatus according to claim 11, wherein,
the indication information is used to indicate that the transmission point or the other transmission points will advance or postpone a predetermined time to schedule the same terminal to communicate with the transmission point or the other transmission points in an overlapped time slot.

14. The apparatus according to claim 11, wherein,
the indication information is used to indicate that the transmission point or the other transmission points do not allocate resources for the same terminal in a coincided area of an overlapped time slot.

15. The apparatus according to claim 11, wherein if the transmission point and the other transmission points serve for a downlink of the same terminal on the overlapped resources at the same time,
the indication information is used to indicate that the transmission point and the other transmission points transmit identical or different data to the terminal.

16. The apparatus according to claim 11, wherein if the transmission point and the other transmission points serve for an uplink of the same terminal on the overlapped resources at the same time,
the indication information is used to indicate that the terminal may transmit identical or different data to the transmission point and the other transmission points at the same time.

17. The apparatus according to claim 11, wherein the apparatus further comprises:
a detecting unit configured to detect whether resources allocated by the transmission point for the terminal are overlapped with resources allocated by the other transmission points for the terminal.

18. The apparatus according to claim 17, wherein the detecting unit detects whether the resources allocated by the transmission point for the terminal are overlapped with the resources allocated by the other transmission points for the terminal according to timing reference information.

19. An apparatus for processing resource overlapping, applicable to a terminal, the apparatus comprising:
a receiving unit configured to receive indication information transmitted by a transmission point, the indication information being used to indicate that resources allocated by the transmission point for the terminal are overlapped with resources allocated by other transmission points for the terminal, and/or a scheduling scheme of the overlapped resources;
wherein, the transmission point and the other transmission points jointly serve for the terminal.
